(19) United States
(12) Patent Application Publication
(10) Pub. No.: US 2009/0069006 A1
(43) Pub. Date: Mar. 12, 2009

(54) METHOD FOR REMOTELY LOGGING DIAGNOSTIC MONITORING DATA FOR MOBILE TELECOMMUNICATION NETWORK

(75) Inventors: Jin Soup Joung, Seongnam-city (KR); Young Su Kwak, Seongnam-city (KR); Oh Keol Kwon, Seongnam-city (KR); Dae Hyun Chung, Seongnam-city (KR)

Correspondence Address: ROTHWELL, FIGG, ERNST & MANBECK, P.C., 1425 K STREET, N.W., SUITE 800, WASHINGTON, DC, 20005, US

(73) Assignee: INNOWIRELESS CO., LTD., Seongnam-city, Gyeonggi-do (KR)

(21) Appl. No.: 12/278,618

(22) PCT Filed: Dec. 19, 2006
(86) PCT No.: PCT/KR2006/005545

§ 371 Date: Oct. 1, 2008

(30) Foreign Application Priority Data
Feb. 8, 2006 (KR) 10-2006-0012099

(51) Int. Cl. H04W 24/00

(52) U.S. Cl. 455/423

(57) ABSTRACT

The present invention relates, in general, to a method for remotely logging diagnostic monitoring message data on a mobile telecommunication network and, more particularly, to a method for remotely logging diagnostic monitoring message data on a mobile telecommunication network, which, in measuring equipment for diagnosing abnormal service in the mobile telecommunication network, is capable of securely logging the diagnostic monitoring message data of a mobile telecommunication terminal to a remote server while minimizing the load on the mobile telecommunication network.

### TECHNICAL FIELD

The present invention relates, in general, to a method for remotely logging diagnostic monitoring message data on a mobile telecommunication network and, more particularly, to a method for remotely logging diagnostic monitoring message data on a mobile telecommunication network, which, in measuring equipment for diagnosing abnormal service in the mobile telecommunication network, is capable of securely logging the diagnostic monitoring message data of a mobile telecommunication terminal to a remote server while minimizing the load on the mobile telecommunication network.

### BACKGROUND ART

Recently, mobile telecommunication terminals have become essential portable items which are necessary among the people. Accordingly, competition between mobile telecommunication service providers to recruit subscribers has become intense. In consideration of this situation, respective mobile telecommunication service providers operate measuring equipment for diagnosing abnormal service in mobile telecommunication networks, operated by them, so as to provide high-quality mobile telecommunication network service. Meanwhile, such measuring equipment must be used while it is moved from place to place because the measuring equipment targets base stations, which are the termination equipment of mobile telecommunication networks. Therefore, various types of diagnostic monitoring message data (hereinafter simply referred to as ‘diagnostic data’) on mobile telecommunication network service is transmitted to a server, which is installed at a fixed remote location, through a mobile telecommunication network, and is stored in the remote server (this work is hereinafter referred to as ‘logging’).

Meanwhile, in general, factors for the analysis of the radio wave environment of a mobile telecommunication network include Receiver Signal Strength Indicator (RSSI), Energy of carrier/Interference of others (Ec/Io), Tx Power, Tx Adjust, Frame Error Rate (FER), and Automatic Gain Control (AGC) values. These values are important factors for the evaluation of the environment of a mobile telecommunication network in a measurement area. In order to calculate these various measurement factors, diagnostic messages, such as a Temporal Analyzer Graph (0X19), a General Temporal Analyzer (0X1019), a General Temporal Analyzer with Supplemental Channels (0X101A), and a Searcher and Finger (0X102D), are used. Each of these factors produces data at intervals of at least 20 ms.

Meanwhile, in the measurement of the various indicators of quality of a mobile telecommunication network, the amount of data is huge, to the extent that it amounts to several gigabytes for measurements spanning only about several hours, whereas the data transmission rate on the mobile telecommunication network is a maximum of only 3000 Kbps in the case of uploading. Therefore, such measurement data cannot be transmitted as it is, but must be sampled and transmitted at predetermined intervals of, for example, 1 second or more.

However, in the above-described sampling transmission, a user must distinguish necessary data from unnecessary data, which is very technical and is too burdensome and unreasonable for a general user to do. In contrast, in the case where the types of data are determined in advance, a problem arises in that various types of measurement are limited. Furthermore, in the case where a diagnostic factor selected by the user is a factor that creates a large amount of data, a burden occurs in that a user must select data at specific time intervals. Moreover, in this case, problems arise in that there is the risk of excluding important data in the data selection process, and in that distorted data may be provided to the user in the radio wave environment of a mobile telecommunication network, which varies in real time.

### DISCLOSURE

### Technical Problem

The present invention has been made keeping in mind the above problems occurring in the prior art, and an object of the present invention is to provide a method for remotely logging diagnostic data on a mobile telecommunication network, which, in measuring equipment for diagnosing abnormal service in a mobile telecommunication network, logs all of the data by uploading the diagnostic data of a mobile telecommunication terminal after compression, checking file validity and then merging the data, thereby securely logging the data to a remote server while minimizing the load on the mobile telecommunication network.

### Technical Solution

In order to accomplish the above object, the present invention provides A method for remotely logging diagnostic data on a mobile telecommunication network, the method being performed between a remote control unit for collecting diagnostic data on a mobile telecommunication network, a data collection server for collecting the diagnostic data transmitted from the remote control unit, and a Point-To-Point Protocol (PPP) server for mediating a connection between the remote control unit and the data collection server, the method comprising the steps of: (a) until measurement is completed, the remote control unit dividing the diagnostic data, collected in real time, into partial files having a predetermined specific size, and compressing each of the partial files; (b) the remote control unit checking validity of the compressed partial file using a predetermined validity checking algorithm, and then storing the compressed partial file therein, with a unique index being assigned thereto; (c) the remote control unit connecting the PPP server to the data collection server, and then transmitting the stored partial file; and (d) when the partial file has been received, the data collection server decompressing the partial file, checking the validity of the partial file, and creating an integrated file and then appending the valid partial file to the integrated file if the partial file is valid.

### ADVANTAGEOUS EFFECTS

According to the above-described method for remotely logging diagnostic data on a mobile telecommunication network of the present invention, in measuring equipment for diagnosing abnormal service in a mobile telecommunication network, all of the data is logged by uploading the diagnostic data of a mobile telecommunication terminal after compression, checking file validity, and then merging the data, thereby securely logging the data to a remote server while minimizing the load on the mobile telecommunication network.

### DESCRIPTION OF DRAWINGS

FIG. 1 is a diagram showing the configuration of a network in which a method for remotely logging diagnostic data on a mobile telecommunication network according to the present invention is implemented;

FIGS. 2 and 3 are flowcharts showing procedures which are performed in a remote control unit, in the method for remotely logging diagnostic data on a mobile telecommunication network according to the present invention; and

FIG. 4 is a flowchart showing a procedure which is performed in the data collection server, in the method for remotely logging diagnostic data on a mobile telecommunication network according to the present invention.

### DESCRIPTION OF REFERENCE NUMERALS OF PRINCIPAL ELEMENTS IN ACCOMPANYING DRAWINGS

100: remote control unit
102, 104: diagnostic data acquisition unit

| | |
|---|---|
| 106: main control unit | 108: communication control unit |
| 110: debugging terminal | 112-118: communication terminal |
| 120: data transmission terminal | 130: PPP server |
| 140: data collection server | 150: analysis server |
| 160: user terminal | |

### MODE FOR INVENTION

With reference to the accompanying drawings, a method for remotely logging diagnostic data on a mobile telecommunication network according to preferred embodiments of the present invention will be described in detail below.

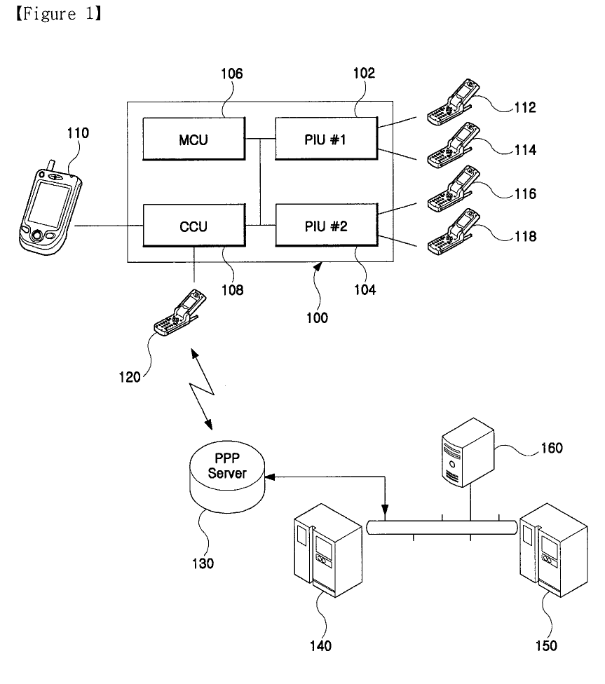

FIG. 1 is a diagram showing the configuration of a network in which the method for remotely logging diagnostic data on a mobile telecommunication network according to the present invention is implemented. As shown in FIG. 1, the configuration of the network in which the method for remotely logging diagnostic data for the mobile telecommunication network according to the present invention is implemented may include a remote control unit 100 installed in a vehicle or some other transportation equipment, and configured to collect diagnostic data on the mobile telecommunication network; a data collection server 140 for collecting diagnostic data transmitted from the remote control unit 100; a Point-To-Point Protocol (PPP) server 130 for mediating a connection between the remote control unit 100 and the data collection server 140; a user terminal 160 for performing functions of setting a series of options related with the measurement of the quality of the mobile telecommunication network, inquiring about the set options, and displaying analyzed measurement data on a screen, that is, for performing the function of a communication interface between a user, each device and each server; and an analysis server 150 for performing functions of reconstructing raw diagnostic data from the point of view of a user, and transmitting analysis results based on the options, set by the user, to the user terminal 160.

In the above-described configuration, the remote control unit 100 may include a main control unit 106 for analyzing data received from a Global Positioning System (GPS; not shown), recording the present location of the remote control unit 100, and connecting the respective units of the remote control unit 100 using a local Ethernet; at least one diagnostic data acquisition unit 102 and 104 for making settings suitable to a measurement environment for connected mobile telecommunication terminals 112 and 116 for data communication and connected mobile telecommunication terminals 114 and 118 for voice communication, and transmitting the diagnostic messages, collected from the respective mobile telecommunication terminals 112 to 118, to a communication control unit to be described later; and a communication control unit 108 for controlling the measuring functions of the respective diagnostic data acquisition unit 102 and 104 and also transmitting the collected diagnostic data to the data collection server 140 through a connected data transmission terminal 120. Here, the data collection server 140 may perform all of the functions of a control and monitoring server for the remote control unit 100, a database server for the collected diagnostic data, and a File Transfer Protocol (FTP) server. It is preferred that the transmitting terminal 120 be implemented as an Evolution Data Only (EVDO) terminal suitable for fast data transmission. The reference numeral 110 designates a debugging terminal for performing functions of debugging the various embedded programs of the communication control unit 108, etc. The debugging terminal 110 may be implemented as, for example, a Personal Digital Assistant (PDA) having Bluetooth communication functionality.

The method for remotely logging diagnostic data on a mobile telecommunication network according to the present invention cannot be realized until a connection is established with the PPP server 130 and the corresponding remote control unit 100 is registered with the Internet environment, when the communication control unit 108 of the remote control unit 100 can make a data communication connection.

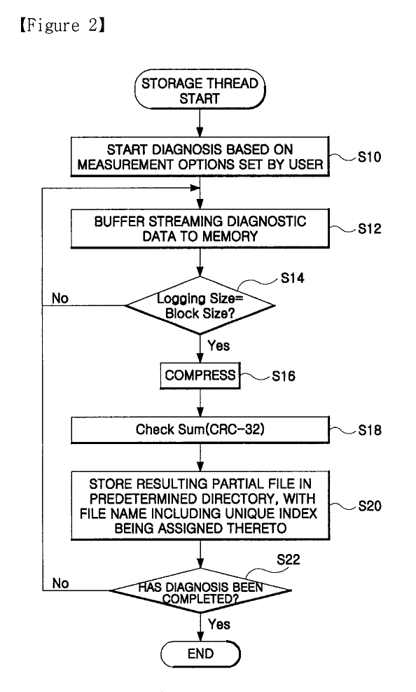

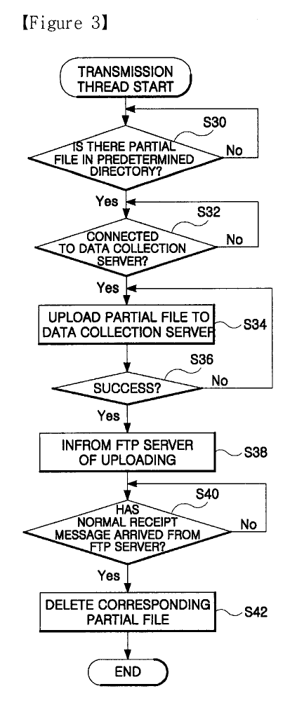

Meanwhile, the remote control unit 100 includes two threads (threads: programming architectural elements for sharing the same memory space and providing different task paths). The first thread (a storage thread illustrated in FIG. 2; to be described later) performs functions of buffering diagnostic data, received from the respective diagnostic data acquisition units 102 and 104, to its own memory, compressing the diagnostic data, and storing the compressed diagnostic data in a predetermined directory of a local disc using a unique file name. The second thread (a transmission thread illustrated in FIG. 3; to be described later) checks whether there is a file in the predetermined directory of the local disc, and transmits the stored file to the data collection server 140 if the stored file exists. The FTP communication protocol, which is already widely used, may be used as the method of transmitting such diagnostic data files.

The size of data to be used for the analysis in the data collection server 140 may vary with the measuring environment. That is, the size of data may range from several megabytes to several hundreds of megabytes depending on the measurement options set by the user. Hereinafter, the size of data to be used for the analysis is defined as ‘the size of analysis data’. Meanwhile, since data on the order of several hundreds of megabytes cannot be transmitted to the data collection server 140 at one time, data is divided into a plurality of pieces of data having a specific size set by the user, and is then transmitted. The specific size may be determined within a range from about 1 to 8 megabytes, and is defined as ‘the size of transmission data’. Several different issues arise due to the size of transmission data. When the size of transmission data is large, the burden of retransmitting the data is high in the case where data transmitted to the data collection server 140 encounters error during transmission. When the size of transmission data is small, there is a disadvantage in that an excessively large number of data files are created in the data collection server 140 for a single piece of analysis data.

Furthermore, the method of the present invention uses data compression to safeguard the measurement data and reduce the load on a network. The reason for using this method is because the diagnostic data collected on the mobile telecommunication is characterized in that similar data is repeated, and the size of the data is remarkably reduced using a compression algorithm if such similar data is repeated according to a specific rule. The present method uses, for example, the compression algorithm ‘bzip2’ as the compression algorithm. A diagnostic data file compressed using the compression algorithm has the size thereof reduced to an average of ⅕ compared to a source file, and this reduction is directly related to the effect of reducing the load on the mobile telecommunication network to ⅕.

Finally, a device for indicating the start of analysis data and the end of the analysis data in data received in a stream is required. The Async-High Level Data Link Control (HLDC) protocol specification is used to perform this function. For example, it is possible to use 0X7F as the start characters of a stream and 0X7E as the end characters of the stream. 0X7F or 0X7E, included in data, is transformed through an exclusive OR operation in conjunction with 0X7D, and 0X7D is inserted before resulting data to identify the resulting data, as defined in the Async-HDLC communication protocol specification. By doing so, 0X7D as well as 0X7E and 0X7F participates in data transformation. By doing so, the start and end of analysis data can be found from data received in a stream.

The remote logging method of the present invention will be described in detail below.

FIGS. 2 and 3 are flowcharts showing procedures which are performed in the remote control unit, in the method for remotely logging diagnostic data on a mobile telecommunication network according to the present invention.

First, as shown in FIG. 2, diagnosis starts according to the measurement options set by a user at step S10, and then steps S12 and S14 are repeatedly performed. With the start of the diagnosis, diagnostic data received in a socket stream is buffered to the main memory until a specific block size is attained. Here, when data indicating the start of the stream is received, buffering starts for the first time. In contrast, when data indicating the end of the stream is received, buffering stops regardless of the size of buffered data, and a flag indicating the end of analyzed data is set in a data buffer. A method of setting the index of a file to “XXXX-00000000” may be used as a method of indicating the start of analyzed data, and a method of setting the index of a file to “XXXX-00000099E” may be used as a method of indicating the end of analyzed data. By doing so, the data collection server 140 can periodically check whether a file assigned the index “E” exists in a specific directory, and merges all the files corresponding to the index of the file into a single integrated file if a file is assigned the index “E”, as will be described later. In the above example, the files to be merged are the files “XXXX-00000000” to “XXX-00000098” and “XXXX-00000099E”.

At step S16, when diagnostic data corresponding to the predetermined block size of a buffer is collected, the collected data is compressed using a predetermined compression algorithm, for example, “bzip2”. Thereafter, at step S18, the validity of the compressed data is checked in the compression process, for example, a “Cyclic Redundancy Check (CRC)-32” value is calculated, and the calculated “CRC-32” value is stored at the end of the compressed partial file. Thereafter, at step S20, the resulting partial file is stored in a predetermined directory of a local disc, with a file name including a unique index assigned thereto. Finally, whether the diagnosis has been completed is determined at step S22. If it has not been completed, the procedure returns to step S12 and continues the data buffering, and the index of the partial file is increased by one whenever a compressed file is created.

Here, a rule for determining the file name of a partial file to be transmitted may be determined as follows: using a predetermined character, for example, ‘%’, as an item for distinguishing a field, using the index of the partial file at the end of the partial file, using a predetermined character, for example, ‘+’, before the index, using ‘E’ as a character indicating the end of the index, and using hexadecimal numbers as PlanKey and Scenario. The file name of a partial file determined by the rule may be, for example, “U-1234%0%200509%20%0000FAE00000000A0203011+00000030.drm.bz2Serial Number % PhoneIndex % YearMonth % Day % PlanKey-Scenar10ID_HourMinuteSecond+Index.Ext.CompExt”, and the name of the final partial file may be, for example, “RCU-1234%0%200509%20% 0000FAE0000000A0203011+00000031E.drm.bz2”.

Next, a description of the transmission thread will be given. Whether there is a compressed partial file of diagnostic data in the predetermined directory of the local disc is determined at step S30. The procedure returns to step S30 if there is no file, whereas the procedure proceeds to step S32 and then determines whether a connection to the data collection server 140 has been set up if there is a file. If, as a result of the determination at step S32, the connection is determined not to have been set up, registration with the PPP server 130 is made, and then an attempt to connect to the data collection server 140 is made. In contrast, if a connection has been set up, the procedure proceeds to step S34 and uploads the partial file to the data collection server 140 using FTP. Thereafter, whether uploading is successful is determined at step S36. The procedure returns to step S34 if uploading is successful, whereas the procedure proceeds to step S38 and then informs the data collection server 140 of the uploading failure if uploading is not successful.

Whether a normal receipt message has arrived from the data collection server 140 is determined at step S40. The procedure returns to step S40 if the message has not arrived, whereas the procedure proceeds to step S42 and then deletes a corresponding partial file if the message has arrived.

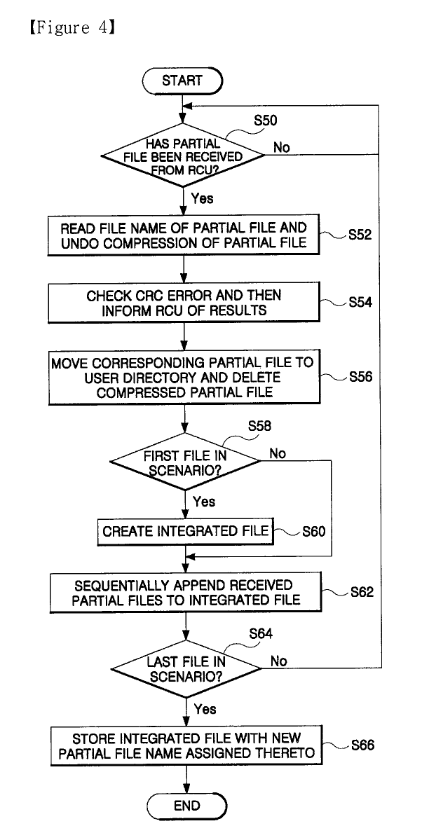

FIG. 4 is a flowchart showing a procedure which is performed in the data collection server, in the method for remotely logging diagnostic data on a mobile telecommunication network according to the present invention. As shown in FIG. 4, first, whether a partial file has been received from the Remote Control Unit (RCU) 100 is determined at step S50. Thereafter, if the partial file has not been received, step S50 is repeated. In contrast, if the partial file has been received, the procedure proceeds to step S52, and reads the file name of the received partial file and then decompress the partial file.

Thereafter, whether there is an abnormality in the diagnostic data is checked by checking a CRC value, and notification of checking results is provided to the RCU 100 at step S54. The RCU 100 retransmits a corresponding partial file to the data collection server if the RCU 100 receives notification that there is an abnormality in the diagnostic data, whereas the RCU 100 deletes a corresponding partial file as described above if the RCU 100 receives notification that there is no abnormality in the diagnostic data. For this purpose, when the RCU 100 transmits a compressed partial file to the data collection server 140, it is preferable to transmit the compressed partial file using “*.bz.tmp”, rather than “*.bz2”, which is a file extension to be checked by the data collection server 140, and then change “*.bz.tmp” to the original name thereof after the transmission has been completed.

Thereafter, the corresponding partial file is moved to the user directory, and then the compressed partial file is deleted at step S56. Then, whether the moved partial file is the first file of a measurement scenario is determined at step S58. The determination may be performed based on the file index described above. If, as a result of the determination at step S58, the moved partial file is the first file of a measurement scenario, the procedure proceeds to step S60 and creates an integrated file, and then proceeds to step S62. In contrast, if the moved file is not the first file, the procedure proceeds directly to step S62 and sequentially appends received partial files to a previously created integrated file. Thereafter, whether a currently received partial file is the last partial file of the measurement scenario is determined at step S64. The procedure returns to step S50 if the received partial file is not the last partial file, whereas the procedure proceeds to step S66 and stores the integrated file with a new file name assigned thereto if the received partial file is the last partial file.

Furthermore, the integrated file, stored as described above, is subsequently provided to the analysis server or the like, and can be usefully used for the user to diagnose abnormal service in a mobile telecommunication network.

### INDUSTRIAL APPLICABILITY

The method for remotely logging diagnostic data on a mobile telecommunication network according to the present invention is not limited to the above-described embodiments, but can be variously modified and worked within a range that does not depart from the technical spirit of the present invention.

1. A method for remotely logging diagnostic data on a mobile telecommunication network, the method being performed between a remote control unit for collecting diagnostic data on a mobile telecommunication network, a data collection server for collecting the diagnostic data transmitted from the remote control unit, and a Point-To-Point Protocol (PPP) server for mediating a connection between the remote control unit and the data collection server, the method comprising the steps of:
(a) until measurement is completed, the remote control unit dividing the diagnostic data, collected in real time, into partial files having a predetermined specific size, and compressing each of the partial files;
(b) the remote control unit checking validity of the compressed partial file using a predetermined validity checking algorithm, and then storing the compressed partial file therein, with a unique index being assigned thereto;
(c) the remote control unit connecting the PPP server to the data collection server, and then transmitting the stored partial file; and
(d) when the partial file has been received, the data collection server decompressing the partial file, checking the validity of the partial file, and creating an integrated file and then appending the valid partial file to the integrated file if the partial file is valid.

2. The method according to claim 1, wherein the division into the partial files having a predetermined specific size at step (a) is determined based on whether the size of the diagnostic data reaches a predetermined buffer size, or whether a predetermined code indicating the end of the diagnostic data is input.

3. The method according to claim 2, wherein the unique index is increased by one whenever the partial file is created.

4. The method according to claim 3, wherein:
if the partial file is not valid at step (d), the data collection server informs the remote control unit thereof; and
if the remote control unit receives information indicating that the partial file is not valid, the remote control unit immediately retransmits the corresponding partial file to the data collection server.

5. The method according to claim 4, wherein,
if the transmission of the partial file has been completed and information indicating that the partial file is valid has been received, the remote control unit deletes the corresponding partial file.

6. (canceled)
